(19) United States
(12) Patent Application Publication
(10) Pub. No.: US 2009/0130289 A1
(43) Pub. Date: May 21, 2009

(54) High Stearic High Oleic Soy Oil Blends

(75) Inventor: Frank R. Kincs, Bourbonnais, IL (US)

Correspondence Address: MCANDREWS HELD & MALLOY, LTD, 500 WEST MADISON STREET, SUITE 3400, CHICAGO, IL, 60661, US

(73) Assignee: Bunge Oils, Inc., St. Louis, MO (US)

(21) Appl. No.: 12/115,330

(22) Filed: May 5, 2008

Related U.S. Application Data
(60) Provisional application No. 60/916,109, filed on May 4, 2007.

(51) Int. Cl. A23D 9/00

(52) U.S. Cl. 426/607

(57) ABSTRACT

A composition comprising high stearic acid, high oleic soybean oil, lightly, partially or fully hydrogenated feedstock oil, and an emulsifier is disclosed. The composition can be used, for example, as a complete shortening composition. A food product employing the complete shortening composition is also described. Several non-limiting examples of the food product are a baked food, such as a short bread cookie, biscuit, pie crust, or puff pastry shell, or icing, such as cake icing or pastry icing.

### CROSS-REFERENCE TO RELATED APPLICATIONS

This application claims the priority of U.S. Ser. No. 60/916,109, filed May 4, 2007. This application is related to co-pending application Ser. No. 11/675,959 filed Feb. 16, 2007. The patent applications referred to above are incorporated by reference in their entireties.

### BACKGROUND OF THE INVENTION

A problem addressed by certain embodiments of this invention is how to make the equivalent of a partially hydrogenated vegetable shortening composition having reduced trans fatty acid content and a low saturated fat content.

Shortening is a fundamental ingredient of baked foods, fried foods, icing, and other foods. Traditional shortenings consist predominantly of a fat or oil. Fats and oils have the same general structure but are in different physical states: An oil is in the liquid state, and a fat is in the solid state.

Chemically, fats and oils are mixtures predominantly composed of triglycerides. A triglyceride molecule is composed of a glycerol moiety and three fatty acid moieties. A fatty acid can be saturated or unsaturated; an unsaturated fatty acid contains one or more double bonds in its hydrocarbon chain, while a saturated fatty acid does not. Triglycerides can also be saturated, if composed of three fully saturated fatty acid moieties per molecule, or unsaturated, if composed of one or more unsaturated fatty acid moieties.

The degree of saturation of a bulk oil or a bulk fatty acid is the average degree of saturation of its constituent glycerides. A fat, oil, or fatty acid having an average of one site of unsaturation per fatty acid moiety is sometimes referred to as monounsaturated, one having more than one site of unsaturation per fatty acid moiety is sometimes referred to as polyunsaturated, and one that has been modified to reduce its natural unsaturation can be fully saturated or partially saturated.

The double bonds of unsaturated fatty acids can be “cis” or “trans” double bonds. In the “cis” isomer, the two hydrogen atoms bonded directly to the respective carbon atoms of the double bond are located on the same side of the double bond—the “lower” side as shown in the following structure:

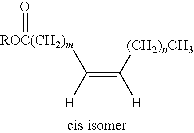

In the “trans” isomer, the two hydrogen atoms bonded directly to the respective carbon atoms of the double bond are located on the opposite sides of the double bond—one “above” and the other “below,” as shown in the following structure:

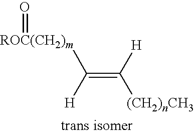

The trans isomer is also referred to as a trans fatty acid.

Saturated fat and trans fatty acid are now regarded as undesirable constituents that must be identified on food labels in the United States.

Traditional animal-derived shortenings such as lard or tallow are predominantly saturated oil. Animal shortening in its native state contains little trans fatty acid, however.

Most natural vegetable oils are less saturated than animal fats and contain essentially no trans fatty acid, and thus are regarded as healthier than lard or tallow. But natural vegetable oils melt at a low temperature and are unstable to oxidation, particularly when polyunsaturated. Most vegetable oils thus are not well suited to function as shortening in their natural state.

Hydrogenation is a chemical reaction in which some or all of the double bonds between carbon atoms are saturated by attachment of an additional pair of hydrogen atoms to the pair of carbon atoms forming the double bond. The double bond thus becomes a single bond. Hydrogenation has been used to make vegetable oils more solid and stable and to increase the quality and storage life of many foods, while providing the attributes of texture and eating quality desired by consumers in fried, baked, or processed foods.

If vegetable oil is fully hydrogenated, it becomes stable and solid, its native unsaturation is eliminated, and essentially no trans fatty acid is produced. But the resulting shortening is fully saturated fat, thus requiring disclosure of a high proportion of saturated fat on labels of foods made with the shortening.

One way to improve the properties of vegetable oils without fully hydrogenating them is to partially hydrogenate them. Partially hydrogenated oils first became popular during the 1960's and 1970's as substitutes for natural animal fats because the partially hydrogenated oils contribute the same or similar desirable characteristics to foods, but provide less saturated fat than animal fats or fully hydrogenated oils. Later, partially hydrogenated oils were also used to replace certain highly saturated vegetable oils. Partially hydrogenated vegetable oils do not easily or quickly become rancid, thus preserving their freshness and extending the shelf life of foods containing them.

But partial hydrogenation introduces trans fatty acid. The naturally selectively cis unsaturation of a natural oil is racemized as a by-product of the hydrogenation process, converting the natural cis unsaturation to a mixture of cis and trans unsaturation. Thus, the very partial hydrogenation process that makes a vegetable oil suitable as shortening, while providing less saturated fatty acid compared to fully saturated shortening, also introduces unwanted trans fatty acid.

It is desirable to reduce to the extent possible the trans fatty acid content of foods. For example, producers of baked foods are demanding shortening that contains less trans fatty acid. Various options have been suggested or tried to avoid trans fatty acids.

One approach to reduce the trans fatty acid content of shortening has been to use vegetable oils having a naturally high saturated fat content (such as palm oil, coconut oil or palm kernel oil). These oils, while lacking trans fatty acids in their natural state, are rich in undesired saturated fat.

Another approach is to use vegetable oils having a high oleic acid content as grown (such as high oleic canola, high oleic safflower, high oleic sunflower, very high oleic sunflower, and extra virgin olive oil); or vegetable oils having a low linolenic acid content (for example, TREUS™ oil, available from Bunge Oils, palm oil, coconut oil or palm kernel oil). These types of oils are more stable against oxidation than polyunsaturated oils like traditional soybean oil. However, in these options, the attribute(s) that confer stability can be variable. For example the attribute may vary because oil seed fatty acid content is susceptible to external environmental conditions either during growing or post harvest processing. Additionally, these oils are not solid at room temperature.

Still another approach is to breed oilseeds capable of directly producing oils high in stearic acid, which is a saturated fatty acid, and high in oleic acid, which is a monounsaturated fatty acid. Such a combination of fatty acids from a single oilseed type would be advantageous because hydrogenation could be avoided, thus avoiding the production of trans fatty acids. The combination of stearic acid and oleic acid from a single oilseed may yield a stable oil with favorable properties for food production. The production of high stearic acid and high oleic acid soybean oilseeds and characterization of the oil extracted is described in U.S. Pat. Nos. 6,229,033 to Knowlton and 6,949,698, to Booth, Jr. et al., both of which patents are incorporated by reference as if entirely reproduced in this disclosure.

It would be desirable to provide an edible fat having the oxidative stability, solid form, and other benefits of partially hydrogenated oil without the drawbacks associated with partial hydrogenation. It would also be desirable to provide edible shortening having a reduced content of saturated fatty acids, compared to a saturated shortening, without an increased content of trans fat.

### BRIEF SUMMARY OF THE INVENTION

One aspect of the invention is a composition comprising high stearic acid, high oleic soybean oil, lightly, partially or fully hydrogenated feedstock oil, and optionally an emulsifier.

Another aspect of the invention is a complete shortening composition consisting essentially of the high stearic acid, high oleic soybean oil formulations described in the preceding paragraph.

Still another aspect of the invention is a food product consisting essentially of the complete shortening composition described in the preceding paragraph. Several non-limiting examples of the food product are a baked food, such as a short bread cookie, biscuit, pie crust, or puff pastry shell, a fried food such as a donut, or icing, such as cake icing or pastry icing.

All proportions or percentages expressed herein are by weight unless otherwise indicated. The weight percent of each fatty acid moiety recited in the claims is expressed as the corresponding weight of a fatty acid methyl ester moiety. The basis of each weight percentage of moieties in an oil is the total weight of all fatty acid moieties in the oil, expressed as the corresponding weight of fatty acid methyl ester moieties. “Oil” and “fat” are used interchangeably here, except when the context clearly indicates otherwise.

### BRIEF DESCRIPTION OF THE FIGURES

FIG. 1 is a graph depicting the evolution of solid fat content (SFC) over time of a high stearic acid, high oleic acid soybean oil (A) and a typical all purpose shortening (B).

FIG. 2 is a graph depicting the evolution of hardness over time of a high stearic acid, high oleic acid soybean oil (A), showing penetration (mm) versus time.

FIG. 3 is a graph depicting the evolution of SFC as a function of time for the S1 sample tempered at 85° F. (29° C.) (5% addition of fully hydrogenated soybean oil to a high stearic acid, high oleic acid soybean oil).

FIG. 4 is a graph depicting the evolution of SFC as a function of time for the S3 sample tempered at 70° F. (21° C.) (5% addition of fully hydrogenated soybean oil and 2.5% addition of An emulsifier to a high stearic acid, high oleic acid soybean oil).

FIG. 5 is a graph depicting the evolution of SFC as a function of time for the S3 sample tempered at 85° F. (29° C.) (5% addition of fully hydrogenated soybean oil and 2.5% addition of An emulsifier to a high stearic acid, high oleic acid soybean oil).

FIG. 6 is a graph depicting the evolution of SFC as a function of time for the S2 sample tempered at 70° F. (21° C.).

FIG. 7 is a graph depicting the evolution of SFC as a function of time for the S2 sample tempered at 85° F. (29° C.).

FIG. 8 is a graph depicting the evolution of SFC as a function of time for the S4 sample tempered at 70° F. (21° C.).

FIG. 9 is a graph depicting the evolution of SFC as a function of time for the S4 sample tempered at 85° F. (29° C.).

FIG. 10 is a graph depicting the hardness of sample S1 tempered at 70° F. (21° C.) as a function of time.

FIG. 11 is a graph depicting the hardness of sample S1 tempered at 85° F. (29° C.) as a function of time.

FIG. 12 is a graph depicting the hardness of sample S3 tempered at 70° F. (21° C.) as a function of time.

FIG. 13 is a graph depicting the hardness of sample S3 tempered at 85° F. (29° C.) as a function of time.

FIG. 14 is a graph depicting the hardness of sample S2 tempered at 70° F. (21° C.) as a function of time.

FIG. 15 is a graph depicting the hardness of sample S2 tempered at 85° F. (29° C.) as a function of time.

FIG. 16 is a graph depicting the hardness of sample S4 tempered at 70° F. (21° C.) as a function of time.

FIG. 17 is a graph depicting the hardness of sample S4 tempered at 85° F. (29° C.) as a function of time.

### DETAILED DESCRIPTION OF THE INVENTION

Certain embodiments of the invention are carried out by mixing a high stearic acid, high oleic acid soybean oil, with one or more oil feedstocks. The oilseeds yielding the oil feedstocks include, but are not limited to, canola, palm, soy, and cottonseed. The oil feedstocks may be lightly hydrogenated oil, preferably fully hydrogenated oil.

A mixture of the high stearic acid, high oleic acid soybean oil and oil feedstocks thus can have a fatty acid distribution resembling that of partially hydrogenated soy oil, without the trans fat content which results from partial hydrogenation. The benefits of partial hydrogenation, such as a higher melting range or improved oxidative stability, may be at least partially obtained, in certain embodiments, partially or entirely without the detriment of a substantial increase in trans fatty acid content.

The high stearic acid, high oleic acid soybean oil useful in this invention as a starting material can be the oil produced as described in U.S. Pat. Nos. 6,229,033 to Knowlton and 6,949,698, to Booth, Jr. et al.

The high stearic, high oleic oil can be defined numerically as having a C18:0 content of at least 15% of the fatty acid moieties in the oil and a C18:1 content of greater than 55%, optionally greater than 60%, optionally greater than 84%, optionally greater than 87%, of the fatty acid moieties in the oil. Optionally, the high stearic, high oleic oil has a combined C18:2 and C18:3 content of less than 7%, optionally less than 6%, optionally less than 5% of the fatty acid moieties in the oil. More specific embodiments are contemplated having:

(1) a C18:0 content of at least 15%, a C18:1 content of greater than 55%, and a combined C18:2 and C18:3 content of less than 7% of the fatty acid moieties in the oil;

(2) a C18:0 content of at least 15%, a C18:1 content of greater than 60%, and a combined C18:2 and C18:3 content of less than 7% of the fatty acid moieties in the oil;

(3) a C18:0 content of at least 15%, a C18:1 content of greater than 84%, and a combined C18:2 and C18:3 content of less than 7% of the fatty acid moieties in the oil;

(4) a C18:0 content of at least 15%, a C18:1 content of greater than 87%, and a combined C18:2 and C18:3 content of less than 7% of the fatty acid moieties in the oil;

(5) a C18:0 content of at least 15%, a C18:1 content of greater than 55%, and a combined C18:2 and C18:3 content of less than 6% of the fatty acid moieties in the oil;

(6) a C18:0 content of at least 15%, a C18:1 content of greater than 60%, and a combined C18:2 and C18:3 content of less than 6% of the fatty acid moieties in the oil;

(7) a C18:0 content of at least 15%, a C18:1 content of greater than 84%, and a combined C18:2 and C18:3 content of less than 6% of the fatty acid moieties in the oil;

(8) a C18:0 content of at least 15%, a C18:1 content of greater than 87%, and a combined C18:2 and C18:3 content of less than 6% of the fatty acid moieties in the oil;

(9) a C18:0 content of at least 15%, a C18:1 content of greater than 55%, and a combined C18:2 and C18:3 content of less than 5% of the fatty acid moieties in the oil;

(10) a C18:0 content of at least 15%, a C18:1 content of greater than 60%, and a combined C18:2 and C18:3 content of less than 5% of the fatty acid moieties in the oil;

(11) a C18:0 content of at least 15%, a C18:1 content of greater than 84%, and a combined C18:2 and C18:3 content of less than 5% of the fatty acid moieties in the oil;

(12) a C18:0 content of at least 15%, a C18:1 content of greater than 87%, and a combined C18:2 and C18:3 content of less than 5% of the fatty acid moieties in the oil;

(13) a C18:0 content of at least 15% and a C18:1 content of greater than 55% of the fatty acid moieties in the oil;

(14) a C18:0 content of at least 15% and a C18:1 content of greater than 60% of the fatty acid moieties in the oil;

(15) a C18:0 content of at least 15% and a C18:1 content of greater than 84% of the fatty acid moieties in the oil;

(16) a C18:0 content of at least 15% and a C18:1 content of greater than 87% of the fatty acid moieties in the oil.

The high stearic acid, high oleic acid soybean oil useful in this invention as a starting material can be the oil produced from the soybean seed that has been deposited with the American Type Culture Collection (ATCC), 10801 University Boulevard, Manassas, Va. 20110-2209, and bears one of the following designations, accession numbers and dates of deposit:

TABLE 1

| Designation | Accession Number | Date of Deposit |
|---|---|---|
| Soybean T1S | ATCC 203033 | May 14, 1998 |
| Soybean L9216116-109 | ATCC 203946 | Apr. 20, 1999 |

High stearic acid, high oleic acid soybean oils produced from the above soybeans or equivalent oilseeds were evaluated for the properties useful in the formulation of shortenings. One such useful property is the solid fat content (SFC) of the oil. High solid fat content in an oil generally yields useful shortening compositions.

A complete high stearic acid, high oleic acid or blended shortening composition is defined as consisting essentially of the high stearic acid, high oleic acid or blended shortening composition described above. Such a composition may also contain other constituents, such as coloring, flavoring, other oils, anti-oxidants or other stabilizers, nutritional supplements, etc.

According to certain embodiments, an emulsifier is a constituent in a shortening composition comprising high stearic acid, high oleic acid soybean oil and another feedstock oil. Emulsifiers are typically used in the food industry to improve texture, stability, volume, softness, aeration, homogenization and shelf life. The use of emulsifiers in a shortening composition depends on the application of the shortening. For example, the function of emulsifiers in a shortening product used in the production of cookies influence the characteristic of spread ratio. Examples of emulsifiers useful in shortening compositions include, but are not limited to, lecithin, food-grade non-ionic emulsifiers, such as fatty acids (C10-C18), monoglycerides and mono-diglycerides, polyglycerol esters, polyethylene sorbitan esters, propolyene glycol, sorbitan monopalmitate, sorbitan monosterate, sorbitan tristerate, other like emulsifiers or combinations thereof. Certain emulsifiers are known under the trade names Estric™ and Dimodan O™ or Dimodan O K™.

In certain embodiments, the shortening composition includes from 1 to 5 wt. %, optionally from 1 to 4.5 wt. %, optionally from 1 to 4.0 wt. %, optionally from 1 to 3.5 wt. %, optionally from 1 to 3.0 wt. %, optionally from 1 to 2.9 wt. %, optionally from 1 to 2.8 wt. %, optionally from 1 to 2.7 wt. %, optionally from 1 to 2.6 wt. %, optionally from 1 to 2.5 wt. %, optionally from 1 to 2.4 wt. %, optionally from 1 to 2.3 wt. %, optionally from 1 to 2.2 wt. %, optionally from 1 to 2.1 wt. %, optionally from 1 to 2.0 wt. %, optionally from 1 to 1.9 wt. %, optionally from 1 to 1.8 wt. %, optionally from 1 to 1.7 wt. %, optionally from 1 to 1.6 wt. %, optionally from 1 to 1.5 wt. %, optionally from 1 to 1.4 wt. %, optionally from 1 to 1.3 wt. %, optionally from 1 to 1.2 wt. %, optionally from 1 to 1.1 wt. %, optionally less than 1 wt. % of an emulsifier.

In certain embodiments, the shortening composition includes a highly or essentially fully hydrogenated oil. Such highly or fully hydrogenated oils are generally comprised of fatty acids with a high degree of saturation. An essentially fully hydrogenated oil may have about 90% or more of its carbon atoms saturated. Such fatty acids are described in Table 2.

TABLE 2

| Traditional | | No. of Carbon | No. of Double |
|---|---|---|---|
| Name | IUPAC Name | Atoms | Bonds |
| Butyric | Butanoic | 4 | 0 |
| Caproic | Hexanoic | 6 | 0 |
| Caprylic | Octanoic | 8 | 0 |
| Capric | Decanoic | 10 | 0 |
| Lauric | Dodecanoic | 12 | 0 |
| Myristic | Tetradecanoic | 14 | 0 |
| Palmitic | hexadecanoic | 16 | 0 |
| Palmitoleic | cis-9-hexadecenoic | 16 | 1 |
| Stearic | octadecanoic | 18 | 0 |
| Oleic | cis-9-octadecenoic | 18 | 1 |
| Ricinoleic | 12-hydroxy-cis- | 18 | 1 |
| | 9-octadecenoic | | |
| Arachidic | eicosanoic | 20 | 0 |
| Gadoleic | cis-9-eicosenoic | 20 | 1 |
| Behenic | docosanoic | 22 | 0 |
| Cetoleic | cis-11-docosenoic | 22 | 1 |
| Erucic | cis-13-docosenoic | 22 | 1 |
| Lignoceric | tetracosanoic | 24 | 0 |

In an optional embodiment, the shortening composition includes from 1 to 20 wt. %, optionally from 1 to 15 wt. %, optionally from 1 to 10 wt. %, optionally from 1 to 9.9 wt. %, optionally from 1 to 9.8 wt. %, optionally from 1 to 9.7 wt. %, optionally from 1 to 9.6 wt. %, optionally from 1 to 9.5 wt. %, optionally from 1 to 9.4 wt. %, optionally from 1 to 9.3 wt. %, optionally from 1 to 9.2 wt. %, optionally from 1 to 9.1 wt. %, optionally from 1 to 9.0 wt. %, optionally from 1 to 8.9 wt. %, optionally from 1 to 8.8 wt. %, optionally from 1 to 8.7 wt. %, optionally from 1 to 8.6 wt. %, optionally from 1 to 8.5 wt. %, optionally from 1 to 8.4 wt. %, optionally from 1 to 8.3 wt. %, optionally from 1 to 8.2 wt. %, optionally from 1 to 8.1 wt. %, optionally from 1 to 8.0 wt. %, optionally from 1 to 7.9 wt. %, optionally from 1 to 7.8 wt. %, optionally from 1 to 7.7 wt. %, optionally from 1 to 7.6 wt. %, optionally from 1 to 7.5 wt. %, optionally from 1 to 7.4 wt. %, optionally from 1 to 7.3 wt. %, optionally from 1 to 7.2 wt. %, optionally from 1 to 7.1 wt. %, optionally from 1 to 7.0 wt. %, optionally from 1 to 6.9 wt. %, optionally from 1 to 6.8 wt. %, optionally from 1 to 6.7 wt. %, optionally from 1 to 6.6 wt. %, optionally from 1 to 6.5 wt. %, optionally from 1 to 6.4 wt. %, optionally from 1 to 6.3 wt. %, optionally from 1 to 6.2 wt. %, optionally from 1 to 6.1 wt. %, optionally from 1 to 6.0 wt. %, optionally from 1 to 5.9 wt. %, optionally from 1 to 5.8 wt. %, optionally from 1 to 5.7 wt. %, optionally from 1 to 5.6 wt. %, optionally from 1 to 5.5 wt. %, optionally from 1 to 5.4 wt. %, optionally from 1 to 5.3 wt. %, optionally from 1 to 5.2 wt. %, optionally from 1 to 5.1 wt. %, optionally from 1 to 5.0 wt. %, optionally from 1 to 4.9 wt. %, optionally from 1 to 4.8 wt. %, optionally from 1 to 4.7 wt. %, optionally from 1 to 4.6 wt. %, optionally from 1 to 4.5 wt. %, optionally from 1 to 4.4 wt. %, optionally from 1 to 4.3 wt. %, optionally from 1 to 4.2 wt. %, optionally from 1 to 4.1 wt. %, optionally from 1 to 4.0 wt. %, optionally from 1 to 3.9 wt. %, optionally from 1 to 3.8 wt. %, optionally from 1 to 3.7 wt. %, optionally from 1 to 3.6 wt. %, optionally from 1 to 3.5 wt. %, optionally from 1 to 3.4 wt. %, optionally from 1 to 3.3 wt. %, optionally from 1 to 3.2 wt. %, optionally from 1 to 3.1 wt. %, optionally from 1 to 3.0 wt. %, optionally from 1 to 2.9 wt. %, optionally from 1 to 2.8 wt. %, optionally from 1 to 2.7 wt. %, optionally from 1 to 2.6 wt. %, optionally from 1 to 2.5 wt. %, optionally from 1 to 2.4 wt. %, optionally from 1 to 2.3 wt. %, optionally from 1 to 2.2 wt. %, optionally from 1 to 2.1 wt. %, optionally from 1 to 2.0 wt. %, optionally from 1 to 1.9 wt. %, optionally from 1 to 1.8 wt. %, optionally from 1 to 1.7 wt. %, optionally from 1 to 1.6 wt. %, optionally from 1 to 1.5 wt. %, optionally from 1 to 1.4 wt. %, optionally from 1 to 1.3 wt. %, optionally from 1 to 1.2 wt. %, optionally from 1 to 1.1 wt. %, optionally less than 1 wt. % of a highly or fully hydrogenated oil.

The compositions of the preceding paragraphs may be processed into shortening compositions using, for example, a scraped surface heat exchanger (SSHE). SSHEs are commonly used in the food, chemical, and pharmaceutical industries for heat transfer, crystallization, and other continuous processes. Certain aspects of SSHE technology are presented in “Scraped Surface Heat Exchangers”, Critical Reviews in Food Science and Nutrition, Volume 46, Number 3, April-May 2006, pp. 207-219(13), which is incorporated by reference.

Still another aspect of the invention is a food product consisting essentially of the complete high stearic acid, high oleic acid or blended shortening composition described above. Several non-limiting examples of the food product are a baked food, such as a short bread cookie, biscuit, pie crust, or puff pastry shell, or an icing.

The baked foods may contain even a predominant proportion of other constituents, for example, flour, sugar or other sweeteners, egg or egg products, milk or milk products such as cream, whipped cream, butter, buttermilk, cream cheese, etc., emulsifiers such as mono- and diglycerides, flavorings such as vanilla or almond extracts, cocoa, cinnamon, coconut, fruit, water, salt, icing, and other ingredients, without limitation.

The icing may contain other constituents, for example, sugar or other sweeteners, egg or egg products, milk or milk products such as cream, whipped cream, butter, buttermilk, cream cheese, etc., emulsifiers such as mono- and diglycerides, flavorings such as vanilla or almond extracts, cinnamon, cocoa, coconut, fruit, water, salt, and other ingredients, without limitation.

### EXAMPLES

The shortening was tested and shown to display acceptable performance in several bakery applications; cookies, pie crust, biscuits, cake and icing. The high stearic acid, high oleic acid soybean oil was also evaluated as the sole oil source in a donut fryer and found to have equal functionality to a highly hydrogenated soybean oil or nonhydrogenated palm oil product.

### Example 1

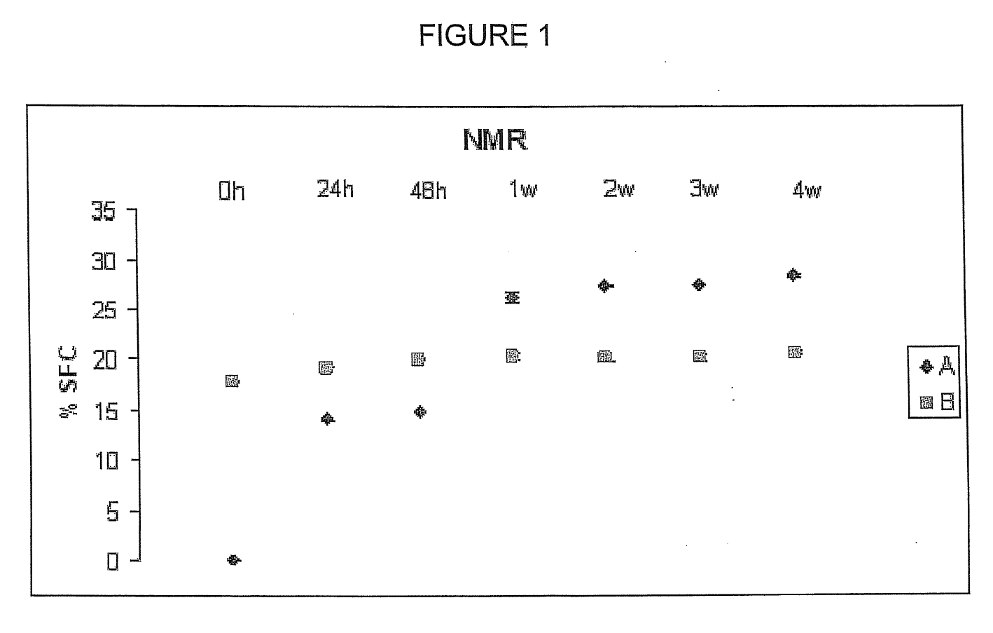

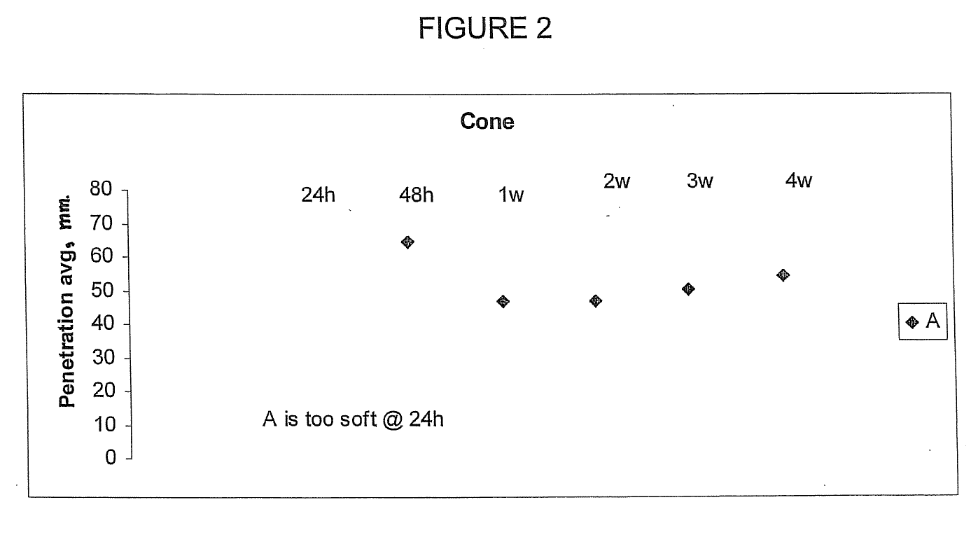

Initial testing of high stearic acid, high oleic acid soybean oils crystallized under a set of different conditions, indicated that the high stearic acid, high oleic acid soybean oil crystallized slowly, increasing its solid content over the period of one week or more, as seen in FIG. 1. Further, the hardness of all purpose-type shortenings crystallized from the high stearic acid, high oleic acid soybean oil increased also over the period of approximately 1 week, as seen in FIG. 2. In addition the crystallized all purpose-type shortening made from the high stearic acid, high oleic acid soybean oil transformed totally to a β˜polymorph after a period of one week.

### Example 2

Four samples were made by mixing the high stearic acid, high oleic acid soybean oil with the following additional components:

TABLE 3

| Sample | Additional components |
|---|---|
| S1 | 5% Fully Hydrogenated Soy Oil |
| S2 | 5% Fully Hydrogenated Cottonseed Oil |
| S3 | 5% Fully Hydrogenated Soy Oil and 2.5% emulsifier |
| S4 | 5% Fully Hydrogenated Cottonseed Oil and 2.5% emulsifier |

### Example 3

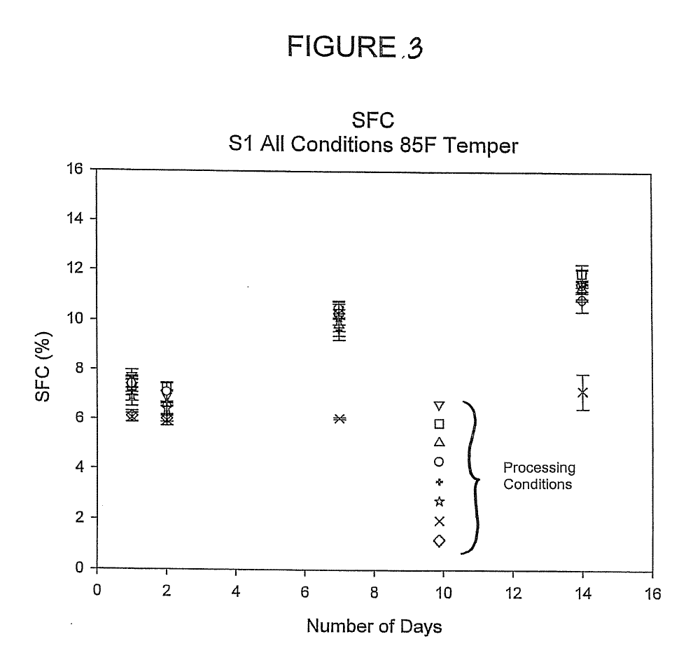

Solid fat content (SFC) for samples S1 to S4 was tested. FIG. 3 shows the variation of solid content of sample S1, tempered at 85° F. (29° C.), as a function of time. For the 70° F. (21° C.) temper, the SFC of sample S1 does not stabilize, even after 7 days, at all processing conditions. Furthermore, at all processing conditions, the SFC is depressed, compared to the 70° F. (21° C.) temper.

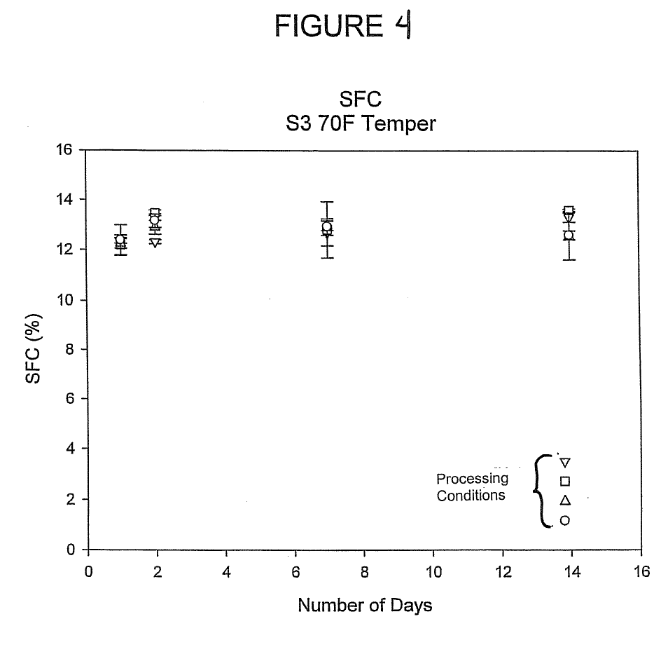

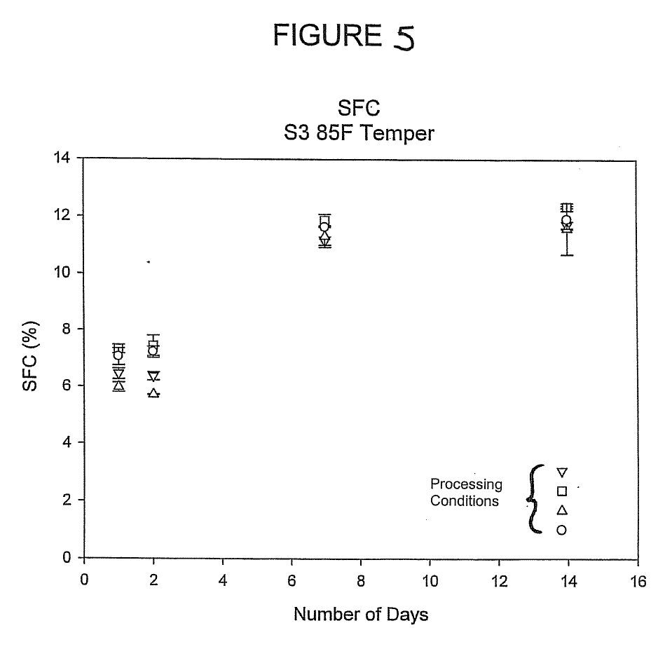

FIGS. 4 and 5 show the variation of solid fat content for sample S3 (additions of 5% fully hydrogenated soybean oil and 2.5% addition of emulsifier), at temper conditions of 70° F. (21° C.) and 85° F. (29° C.), respectively. As demonstrated by FIG. 4, the addition of emulsifier appears to result in the development of a stable solid fat content level after 48 h. Further, the different processing conditions appear to have very little effect on the level of the solid content itself.

At the 85° F. (29° C.) temper, the results appear different. Increases in solid content are observed after the 48 h period.

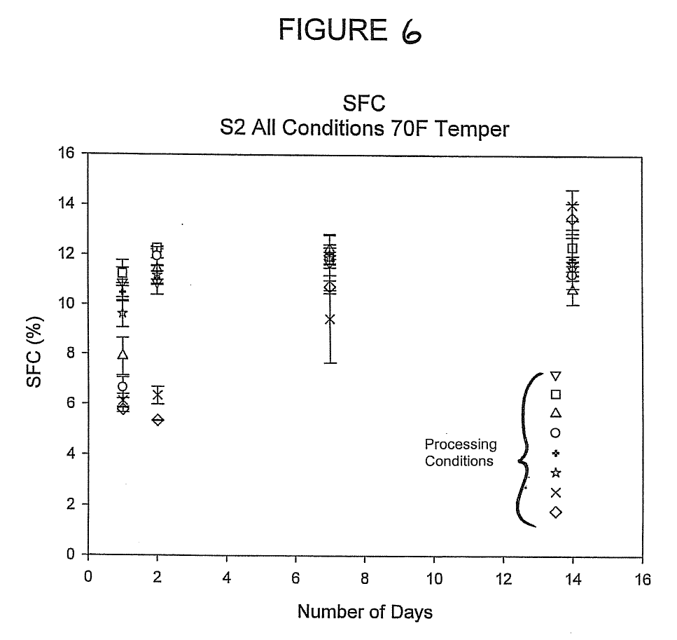

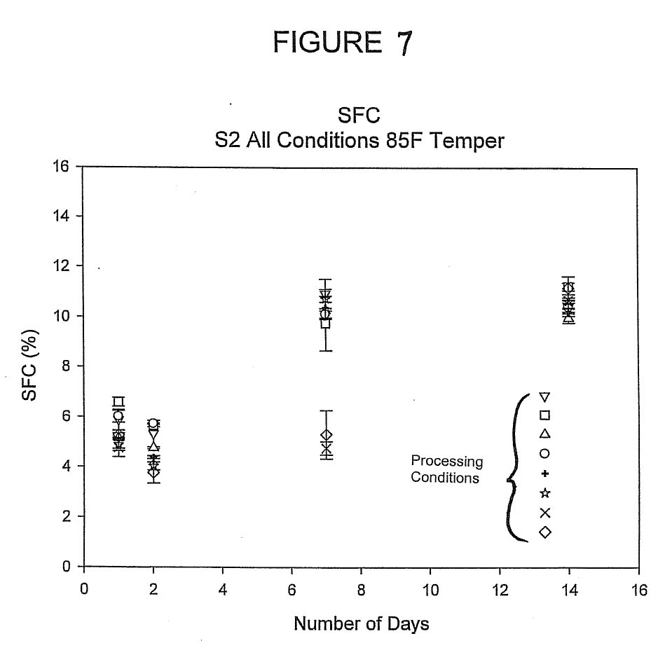

FIGS. 6 and 7 show the variation of solid fat content of sample S2 (addition of 5% fully hydrogenated cottonseed oil) at temper conditions of 70° F. (21° C.) and 85° F. (29° C.). Referring to FIG. 6, at almost all conditions, the final SFC is developed after 48 hours for sample S2 at a 70° F. (21° C.) temper.

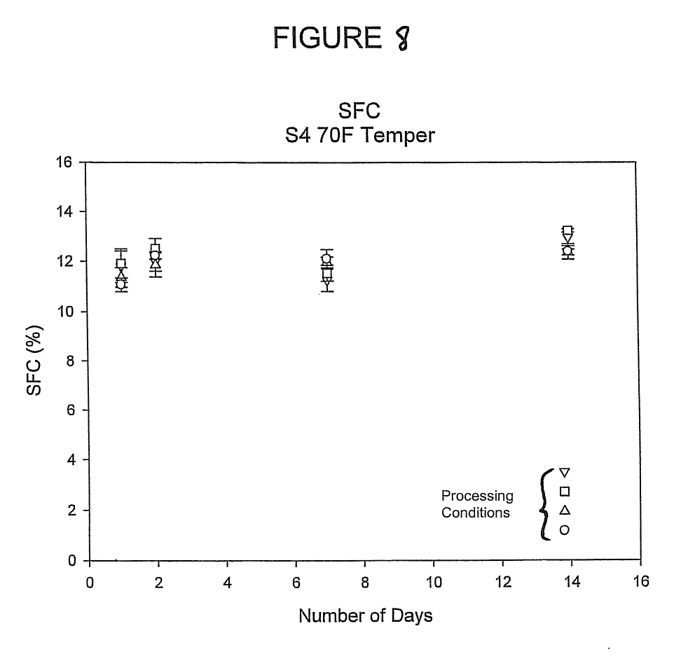

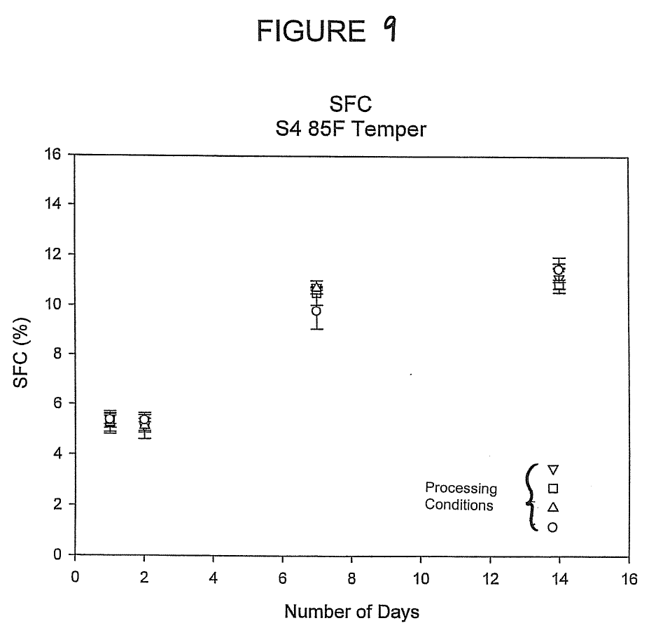

FIGS. 8 and 9 show the variation of solid fat content for sample S4 (additions of 5% fully hydrogenated cottonseed oil and 2.5% addition of emulsifier), at temper conditions of 70° F. (21° C.) and 85° F. (29° C.), respectively. Referring to FIG. 8, it appears that the S4 sample tempered at 70° F. (21° C.) quickly develops its final SFC for all processing conditions, well within the 48 h period. Although sample S2 also develops final SFC early, sample S4 does so faster and for all processing conditions. This suggests that the beneficial effects of the Emulsifier, seen for sample S3 is also useful in sample S4.

### Example 4

A texture analyzer was used for hardness measurements of the samples from Example 2. Measurements were reported as an average and standard deviation of 12 measurements.

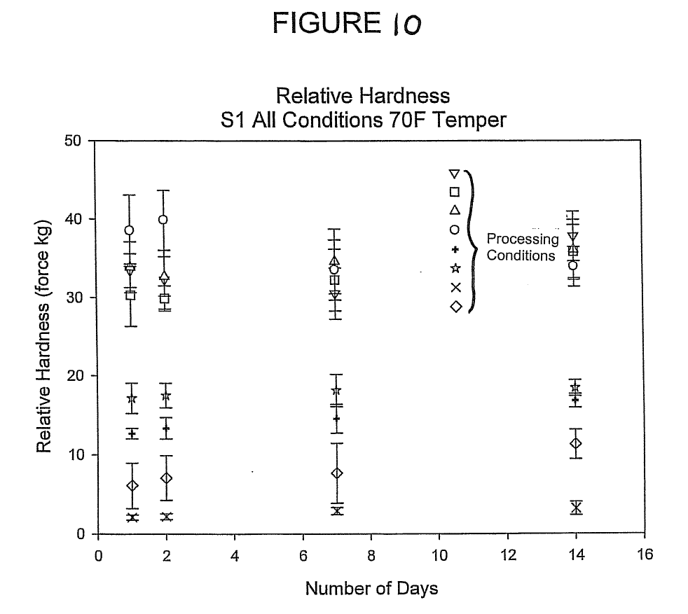

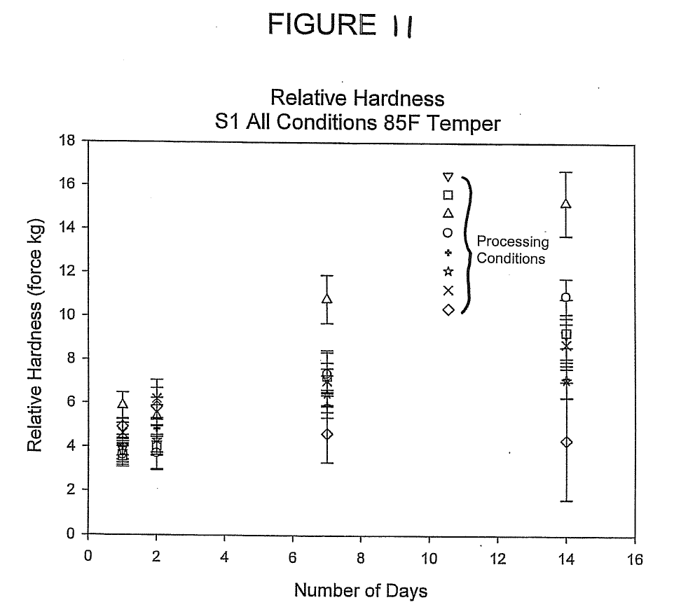

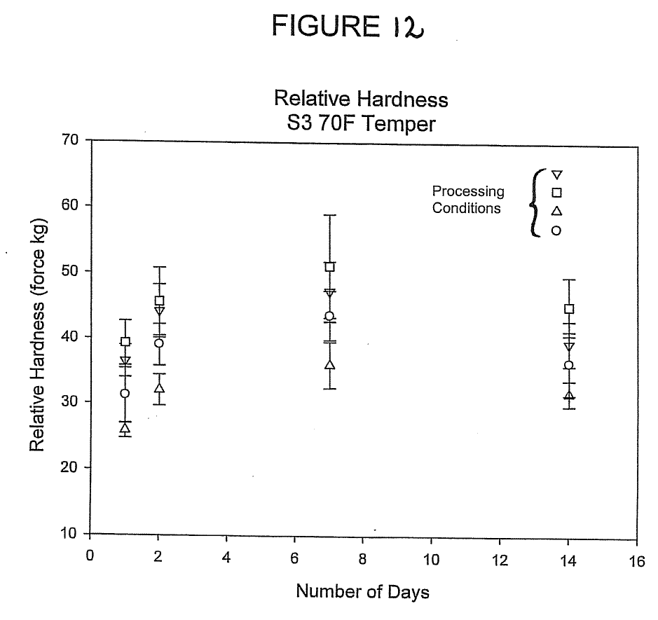

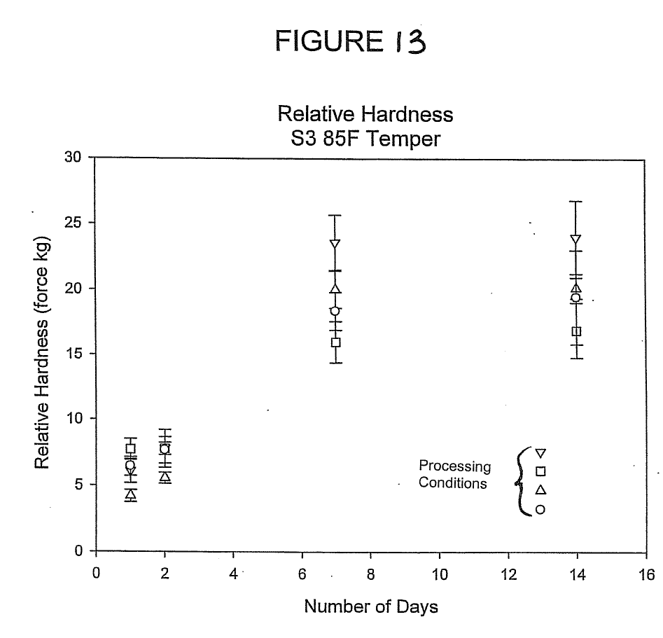

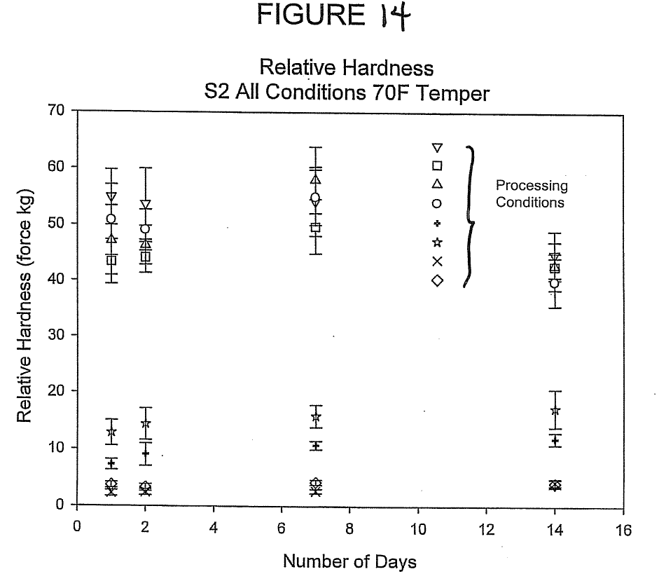

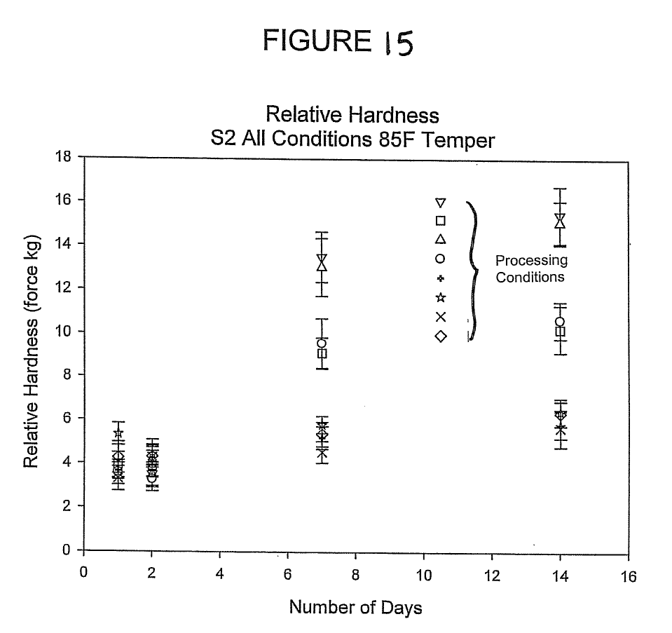

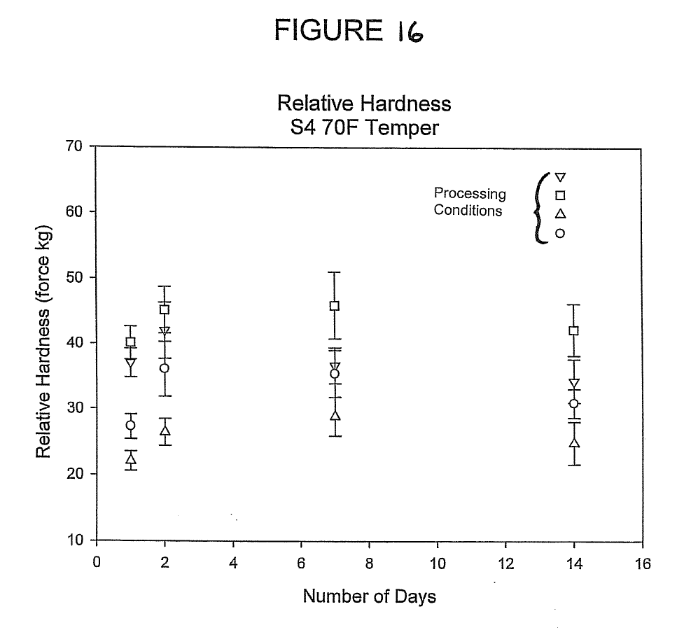

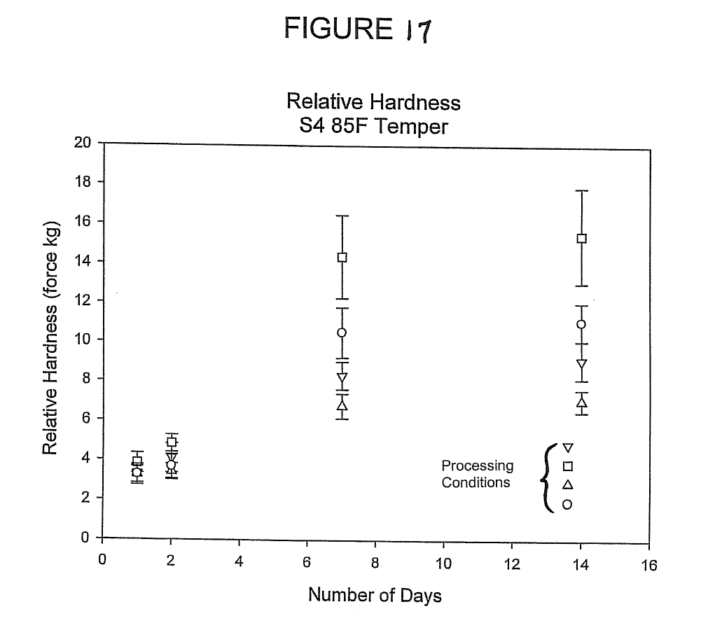

FIGS. 10 and 11 demonstrate the evolution of hardness of sample S1 as a function of time, at tempers of 70° F. (21° C.) and 85° F. (29° C.), respectively. FIGS. 12 and 13 demonstrate the evolution of hardness of sample S3 as a function of time, at tempers of 70° F. (21° C.) and 85° F. (29° C.), respectively. FIGS. 14 and 15 demonstrate the evolution of hardness of sample S2 as a function of time, at tempers of and 85° F. (29° C.), respectively. FIGS. 16 and 17 demonstrate the evolution of hardness of sample S4 as a function of time, at tempers of 70° F. (21° C.) and 85° F. (29° C.), respectively.

### Example 5

A wet cream test was conducted on the certain shortenings of Example 2 and a partially hydrogenated soybean oil/cottonseed oil blended shortening containing emulsifiers (Vreamay®, available from Bunge Oils, Inc.) was used as a control material. The shortenings tested in this example were selected, in part, based on their performance in Examples 3 and 4.

A wet cream test is carried out to determine the ability of shortening to cream or entrap air, measured by determining the specific gravity of each wet cream composition. A greater ability to entrap air, thus a lower specific gravity, indicates superior performance in this test. The results of testing are summarized below in Table 4.

TABLE 4

| | | S1-70F | S2-70F | S3-70F | S4-70F | S1-85F | S2-85F | S3-85F | S4-85F |
|---|---|---|---|---|---|---|---|---|---|
| | | Process | Process | Process | Process | Process | Process | Process | Process |
| | Control | No. 1 | No. 2 | No. 3 | No. 4 | No. 1 | No. 2 | No. 3 | No. 4 |
| Specific | 0.6301 | 0.8793 | 0.6931 | 0.9386 | 0.8302 | 0.7942 | 0.692 | 0.8342 | 0.7907 |
| Gravity | | | | | | | | | |
| Appearance | Slightly | Shiny, | Shiny, | Shiny, | Shiny, | Shiny, | Shiny, | Shiny, | Shiny, |
| | Smooth | Smooth | Smooth | Smooth | Smooth | Smooth | Smooth | Smooth | Smooth |
| | with | with | with | with | with | with | with | with | with |
| | moderate | some air | some air | some air | some air | some air | some air | some air | some air |
| | air | cells | cells | cells | cells | cells | cells | cells | cells |
| Smoothness | 2 | 3 | 3 | 3 | 3 | 3 | 3 | 3 | 3 |
| Score | | | | | | | | | |
| Slide/Slump | Slide 0/ | Failed/ | Slide 0/ | Failed/ | Slide 0/ | Failed/ | Failed/ | Failed/ | Failed/ |
| Test | Slump 0 | Too | Slump 35 | Too | Slump 12 | Too | Too | Too | Too |
| | | Runny | | Runny | | Runny | Runny | Runny | Runny |

Samples S2 and S4 tempered at 70° F. (21° C.) had the lowest final specific gravities of all the high stearic acid, high oleic acid soybean oil shortenings tested, indicating the best ability to cream air. The specific gravities of both of these samples compared favorably with the control.

### Example 6

A typical cookie formula was used to prepare cookies using certain shortenings of Example 2 and Vream® partially hydrogenated soybean oil/cottonseed oil blended shortening as a control material. The shortenings tested in this example were selected, in part, based on their performance in Examples 3 and 4. Three cookies made with each sample were placed side by side to measure spread. To compensate for cookie irregularities, the same three cookies were measured three times and the average of the three readings was recorded in centimeters as the spread. The spread factor was calculated as compared to the control. The results of testing are summarized in Table 5.

TABLE 5

| Sample | Spread Factor | Average Spread | Average Height |
|---|---|---|---|
| S3-70F | 88.00% | 8.6 cm | 0.85 cm |
| S3-85F | 81.00% | 8.6 cm | 0.92 cm |
| S4-70F | 79.00% | 8.3 cm | 0.92 cm |
| S4-85F | 82.00% | 8.5 cm | 0.90 cm |
| CONTROL | 100.00% | 8.6 cm | 0.75 cm |

Sample 1, tempered at 70° F. (21° C.) and processed at low pump speed, low fill temperature, and high perfecter RPM performed comparably to control.

### Example 7

A typical cake formula was used to prepare cookies using the shortenings of Example 5 and Vreamay®, available from Bunge Oils, Inc., as a control material. A texture analyzer was used, in accordance with Example 4, to test the hardness of cakes made from the samples of Table 3. The specific gravity, viscosity, and volume were also measured. The results of testing are summarized in Table 6.

TABLE 6

| | | | | |
|---|---|---|---|---|
| | Average | Specific | | |
| Sample ID | Hardness* | Gravity | Viscosity | Volume |

| | | | | | |
|---|---|---|---|---|---|
| S1 70F | 4634.31 | 1.2772 | 8200 | cP | 685 |
| S1 85F | 2962.66 | 1.3124 | 7800 | cP | 735 |
| S2 70F | 2447.23 | 1.0941 | 15200 | cP | 835 |
| S2 85F | 4949.42 | 1.2356 | 9800 | cP | 735 |
| S3 70F | 4793.39 | 1.2561 | 7800 | cP | 735 |
| S3 85F | 6807.95 | 1.3102 | 7200 | cP | 710 |

| | | | | |
|---|---|---|---|---|
| S4 70F | 3121.69 | 1.2259 | 12800.00 | 810 |
| S4 85F | 5280.58 | 1.2332 | 7000.00 | 710 |

### Example 8

A shortening composition made from 100% high stearic acid, high oleic acid soybean oil (“test shortening”) and a partially hydrogenated shortening, Bunge VFD, were used in a donut fryer to prepare cake donuts for evaluation. A full batch of donuts was fried in each shortening sample prior to sugaring with donut coating sugar. Sugared donuts were placed on a marked tray for storage testing.

The donuts prepared were tested for fat absorption, preference sensory testing, and sugar retention/appearance after storage. A small preference panel for appearance was performed on both the test and control fried donuts after 1 day of storage at 70° F. (21° C.). Sugared donuts were stored at both 70° F. (21° C.) and 85° F. (29° C.) for appearance testing after 24, 48 and 7 days of storage.

The test shortening produced similar shaped and quality donuts to the control shortening. Both the test and control donuts were submitted for analysis and showed similar fat and moisture content. The results of testing are summarized in Table 7.

TABLE 7

| | | Average % |
|---|---|---|
| Sample | Average % Fat | Moisture |
| Test Donut | 22.65 | 33.56 |
| Control Donut | 22.85 | 30.52 |

Since shortening odor and color can be adjusted with optimal processing conditions, these attributes were not as important as the shape and quality of the donuts formed. Both the control and the test donuts performed similar in sugaring storage testing. No changes were noted in sugared donuts after 1 week of storage at 85° F. (29° C.) in the control donuts or the test donuts. The test shortening performed well in cake donut applications and produced acceptable donuts compared to the control shortening.

While the invention has been described with reference to certain embodiments, it will be understood by those skilled in the art that various changes may be made and equivalents may be substituted without departing from the scope of the invention. In addition, many modifications may be made to adapt a particular situation or material to the teachings of the invention without departing from its scope. Therefore, it is intended that the invention not be limited to the particular embodiment disclosed, but that the invention will include all embodiments falling within the scope of the appended claims.

1. A shortening composition comprising: a high stearic acid, high oleic acid soybean oil and a hydrogenated oil.

2. The shortening composition of claim 1 wherein the hydrogenated oil is a partially hydrogenated oil.

3. The shortening composition of claim 2 wherein the hydrogenated oil is selected from the group consisting of canola oil, palm oil, soybean oil, and cottonseed oil.

4. The shortening composition of claim 1 wherein the hydrogenated oil is an essentially fully hydrogenated oil.

5. The shortening composition of claim 1 wherein the weight percent of hydrogenated oil ranges from about 1 wt. % to about 10 wt. %.

6. The shortening composition of claim 1 wherein the weight percent of hydrogenated oil is about 5 wt. %.

7. The shortening composition of claim 1, further comprising an emulsifier.

8. The shortening composition of claim 7, wherein the emulsifier is a food-grade non-ionic emulsifier.

9. The shortening composition of claim 7, wherein the emulsifier is selected from the group consisting of lecithin, fatty acids (C10-C18), monoglycerides and mono-diglycerides, polyglycerol esters, polyethylene sorbitan esters, propylene glycol, sorbitan monopalmitate, sorbitan monosterate, sorbitan tristerate, or combinations thereof.

10. The shortening composition of claim 7 wherein the weight percent of emulsifier ranges from about 1 wt. % to about 5 wt. %.

11. The shortening composition of claim 7 wherein the weight percent of emulsifier is about 2.5 wt. %.

12. The shortening composition of claim 7 wherein the emulsifier comprises a monoglyceride.

13. The shortening composition of claim 7 wherein the shortening has been tempered.

14. The shortening composition of claim 13 wherein the shortening composition has been tempered at an essentially fixed temperature.

15. A low trans fat food product made from a shortening composition of claim 1.
